(19) United States
(12) Patent Application Publication
(10) Pub. No.: US 2012/0112429 A1
(43) Pub. Date: May 10, 2012

(54) Detachable Top Tube Apparatus for a Bicycle

(76) Inventors: Kun-Jie Wang, Taichung City (TW); Rong-Jin Liang, Taichung City (TW); David Tsai, Taichung City (TW)

(21) Appl. No.: 12/940,269

(22) Filed: Nov. 5, 2010

(51) Int. Cl. B62K 19/00

(52) U.S. Cl. 280/281.1

(57) ABSTRACT

A detachable top tube apparatus includes two tubes, two spring-biased detents, two hooks, two latches and an elastic element. The tubes are telescopically connected to each other. Each of the spring-biased detents is connected to a related one of the tubes. Each of the hooks includes a portion inserted in a related one of the tubes. Each of the latches each including two wings pivotally connected to a related one of the tubes between a releasing position and a locking position. In the releasing position, each of the latches allows a portion of a bicycle to be hooked by and unhooked from the related hook. In the locking position, each of the latches retains the portion of the bicycle hooked by the related hook. The elastic element interconnects the tubes.

### BACKGROUND OF INVENTION

1. Field of Invention

The present invention relates to a bicycle and, more particularly, to a detachable top tube apparatus or crossbar for a bicycle.

2. Related Prior Art

There are bicycles for men and bicycles for ladies. A lady's bicycle includes a lowered top tube or does not include any top tube at all. A female rider can mount the lady's bicycle easily by lifting her right leg just a little and seep her right leg over the lowered top tube or the down tube of the lady's bicycle. Thus, she avoid an embarrassing movement of lifting her right leg high and sweep her right leg over the saddle of the lady's bicycle. There is however a problem in carrying the lady's bicycle on a rack attached to the back of a car.

Disclosed in Taiwanese Patent Application Publication No. 383709 is a detachable top tube apparatus 10 for a bicycle. The top tube 10 includes a first tube 12, a second tube 13 telescopically inserted in the first tube 12, a first attaching unit connected to the first tube 12, and a second attaching unit connected to the second tube 13. The first attaching unit includes a hook 15 and a latch 16. Both of the hook 15 and the latch 16 are located on an external side of the first tube 12. The hook 15 is non-pivotally connected to the first tube 12 by a threaded bolt 24 and a rivet 25. The latch 16 is pivotally connected to the first tube 12 by the threaded bolt 24. The latch 16 can be pivoted between a locking position and a releasing position. The latch 16 can be retained in the locking position by a spring-biased detent 22 attached to the first tube 12. The second attaching unit includes a hook 17 and a latch 18. Both of the hook 17 and the latch 18 are located on an external side of the second tube 13. The hook 17 is non-pivotally connected to the second tube 13 by a threaded bolt 26 and a rivet 27. The latch 18 is pivotally connected to the second tube 13 by the threaded bolt 26. The latch 18 can be pivoted between a locking position and a releasing position. The latch 18 can be retained in the locking position by a spring-biased detent 23 attached to the second tube 13. In use, the latches 16 and 18 are located in the releasing position, and the hooks 15 and 17 are engaged with the stem and seat post of a lady's bicycle. The latches 16 and 18 are moved to the locking position and remained there by the spring-biased detents 22 and 23. Problems are however encountered in the use of the detachable top tube apparatus 10. At first, the threaded bolt 24 and 26 and the rivets 25 and 27 bear the weight of the detachable top tube apparatus 10 and the lady's bicycle. The strength of the detachable top tube apparatus 10 is inadequate. The security of the transportation of the lady's bicycle on a rack attached to a car is not ensured. Secondly, many of the elements are located on the external side of the first and second tubes 12 and 13. The risks of scratching the lady's bicycle are high. Thirdly, the pivotal of the latches 16 and 18 might be hindered by the stem and seat post of the lady's bicycle. The detachable top tube apparatus 10 could not be used for various types of lady's bicycles.

Another detachable top tube apparatus for a bicycle is disclosed in U.S. Pat. No. 6,471,232 issued to the present applicant. The detachable top tube apparatus includes a first tube 10 telescopically inserted in a second tube 20, a first attaching unit connected to the first tube 10, and a second attaching unit connected to the second tube 20. The first attaching unit includes a hook 40 and a latch 60. The hook 40 includes a first end 42 fit in the first tube 10.

The connection of the hook 40 to the first tube 10 is enhanced by a pin 81. The latch 60 is located on an external side of the first tube 10 and pivotally connected to the first tube 10 by the pin 81. The latch 60 can be pivoted between a locking position and a releasing position. The latch 60 can be retained in the locking position by a spring-biased stem 83 attached to the first tube 10. The second attaching unit includes a hook 50 and a latch 70. The hook 50 includes a first end 52 fit in the second tube 20. The connection of the hook 50 to the second tube 20 is enhanced by a pin 91. The latch 70 is located on an external side of the second tube 20 and pivotally connected to the second tube 20 by the pin 91. The latch 70 can be pivoted between a locking position and a releasing position. The latch 70 can be retained in the locking position by a spring-biased stem attached to the second tube 20. In use, the latches 60 and 70 are located in the releasing position, and the hooks 40 and 50 are engaged with the stem and seat post of a lady's bicycle. The latches 60 and 70 are moved to the locking position and remained there by the spring-biased detents. It would be better for a section of the second tube 20 to be inserted in the first tube 10 or one of them might be missing. This is however inconvenient for storage.

The present invention is therefore intended to obviate or at least alleviate the problems encountered in prior art.

### SUMMARY OF INVENTION

It is the primary objective of the present invention to provide a detachable top tube apparatus for a bicycle that can easily be stored without risks of any parts thereof missing.

To achieve the foregoing objective, the detachable top tube apparatus includes two tubes, two spring-biased detents, two hooks, two latches and an elastic element. The tubes are telescopically connected to each other. Each of the spring-biased detents is connected to a related one of the tubes. Each of the hooks includes a portion inserted in a related one of the tubes. Each of the latches each including two wings pivotally connected to a related one of the tubes between a releasing position and a locking position. In the releasing position, each of the latches allows a portion of a bicycle to be hooked by and unhooked from the related hook. In the locking position, each of the latches retains the portion of the bicycle hooked by the related hook. The elastic element interconnects the tubes.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a detachable top tube apparatus for a lady's bicycle according to the preferred embodiment of the present invention;

FIG. 2 is a perspective view of the detachable top tube apparatus in another position than shown in FIG. 1;

FIG. 3 is a partial, top view of the detachable top tube apparatus shown in FIG. 1; and

FIG. 4 is an enlarged cross-sectional view of the detachable top tube apparatus shown in FIG. 1.

### DETAILED DESCRIPTION OF PREFERRED EMBODIMENT

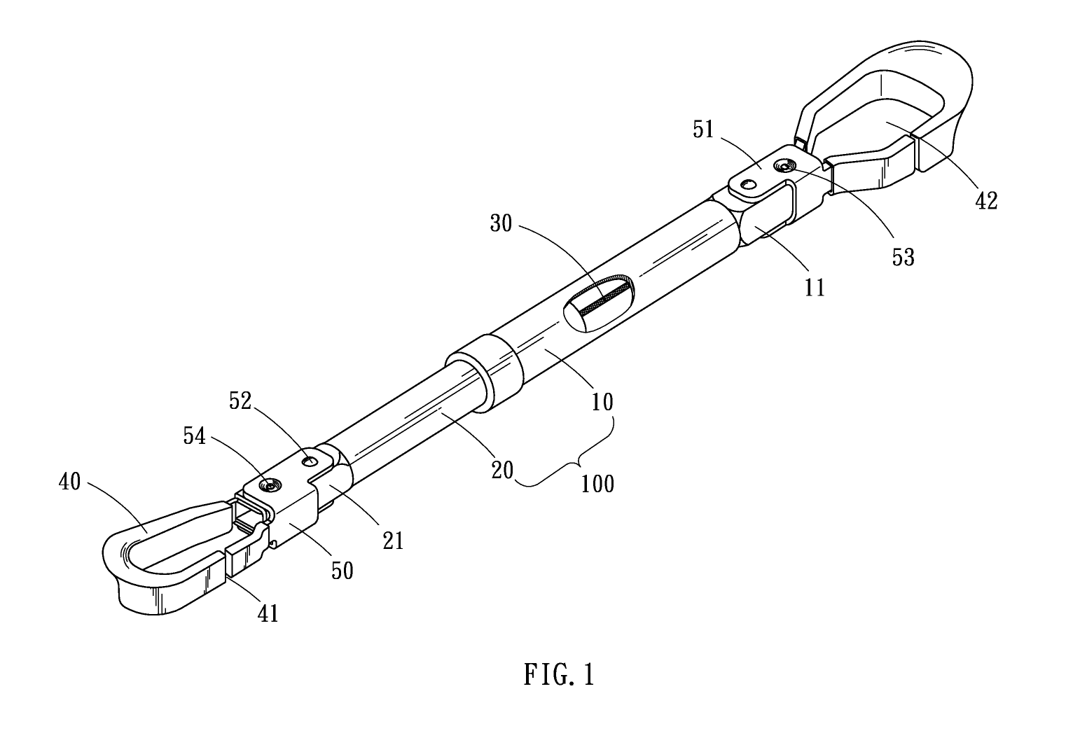

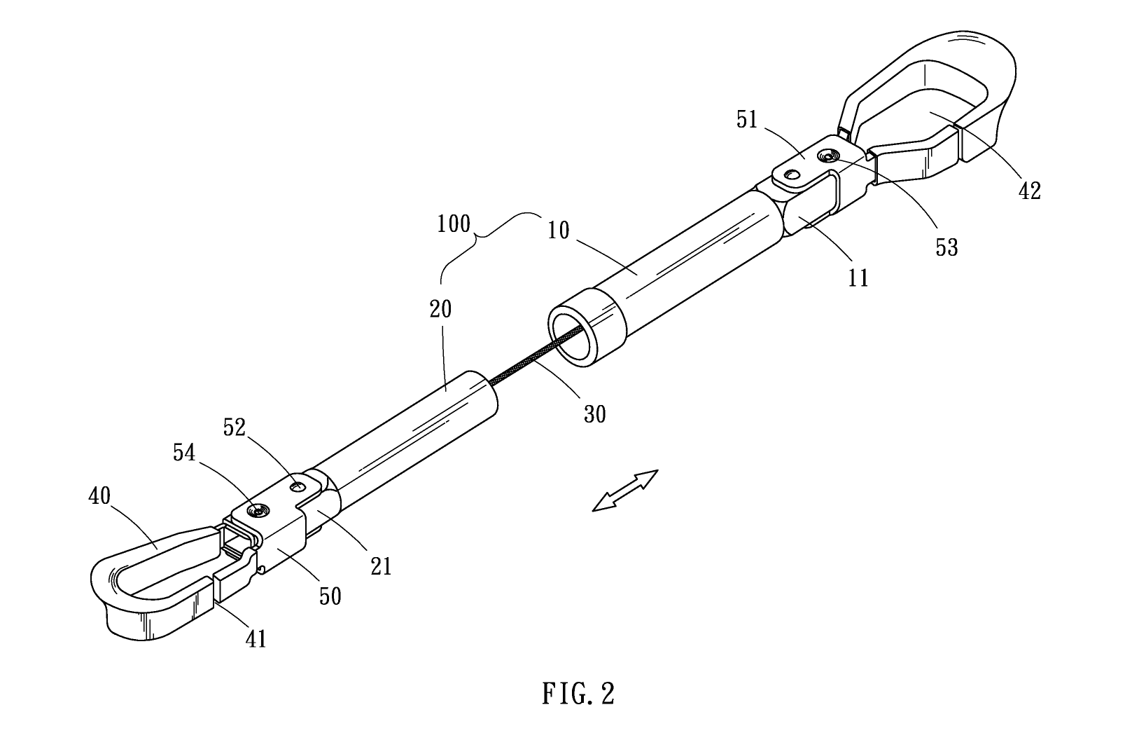

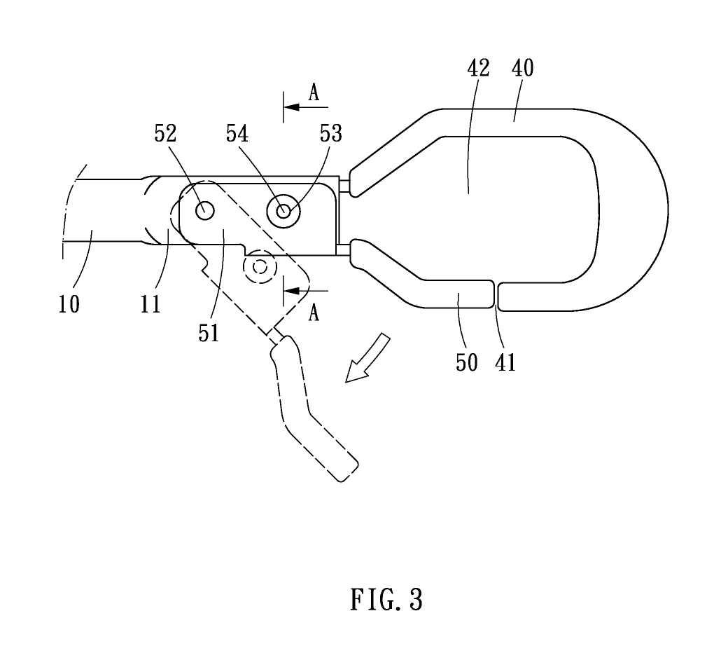

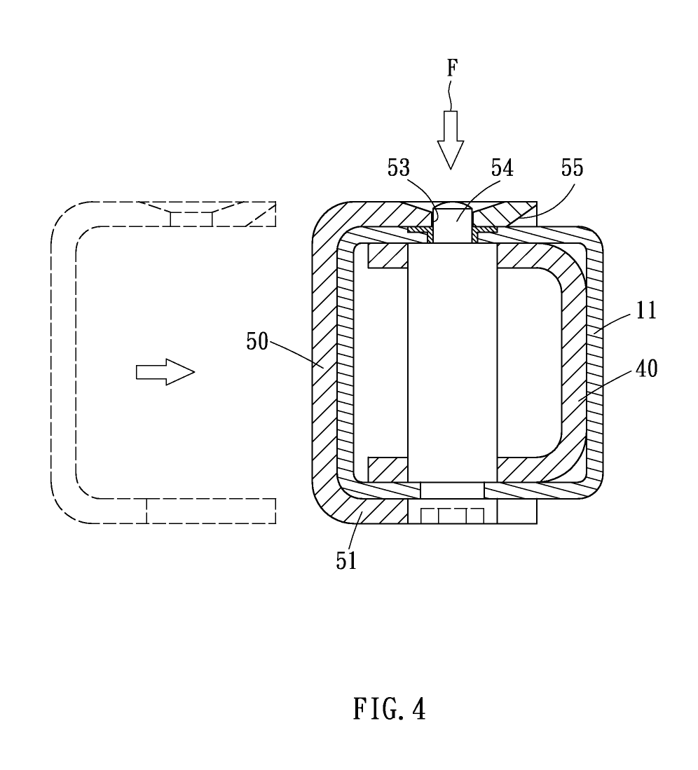

Referring to FIGS. 1 through 4, there is shown a detachable top tube apparatus 100 for a bicycle according to the preferred embodiment of the present invention. The detachable top tube apparatus 100 includes a first tube 10, a second tube 20 telescopically inserted in the first tube 10, an elastic element 30 for interconnecting the tubes 10 and 20, and two attaching units each connected to a related one of the tubes 10 and 20.

The first tube 10 includes a circular end and a rectangular end 11 opposite to the circular end. The second tube 20 includes a circular end and a rectangular end 21 opposite to the circular end. The circular end of the second tube 20 is telescopically inserted in the circular end of the first tube 10. The elastic element 30 includes two ends each located in and tied or hooked to a relative one of the tubes 10 and 20. The elastic element 30 keeps the tubes 10 and 20 connected to each other while allowing the circular ends of the tubes 10 and 20 to be detached from each other. The elastic element 30 allows the tubes 10 and 20 to be arranged parallel to each other for easy storage without the risk of any of them missing. The elastic element 30 is an elastic rope, an elastic belt or a spring.

Each of the attaching units includes a hook 40 and a latch 50. The hook 40 includes a shank extending from an end and a tip extending from another end. The hook 40 includes a gap 41 defined between the tip and the shank and a space 42 for receiving the stem or seat post of the bicycle. The shank of the hook 40 includes a wall that looks like a “U” in a cross-sectional view.

The latch 50 includes a tip extending from an end and a shank extending from another end. The shank of the latch 50 includes a middle portion extending between two wings 51. The tip extends from the middle portion of the shank of the latch 50. A selected one of the wings 51 includes an aperture 53 defined therein and a slope 55 formed in an edge. The distance between the slope 55 of the selected wing 51 and the other wing 51 gets longer in a direction away from the middle portion of the shank of the latch 50.

In assembly, the U-shaped shank of the hook 40 is non-rotationally fit in the rectangular end 11 or 21 of the tube 10 or 20. The connection of the shank of the hook 40 to the rectangular end 11 or 21 of the tube 10 or 20 is enhanced by a threaded bolt 52 engaged with a nut. The wings 51 of the shank of the latch 50 are located against two opposite portions of the rectangular end 11 or 21 of the tube 10 or 20. The latch 50 is pivotally connected to the rectangular end 11 or 21 of the tube 10 or 20 by the threaded bolt 52. In use, the latch 50 can be pivoted between a locking position and a releasing position. The latch 50 can be retained in the locking position by a spring-biased detent 54 attached to the tube 10 or 20. Further details of the detachable top tube apparatus 100 can be found in U.S. Pat. No. 6,471,232.

In use, the latch 50 is located in the releasing position, and the hook 40 is engaged with the stem or seat post of a bicycle. The latch 50 is moved to the locking position and remained there by the spring-biased detent 54 inserted in the aperture 53. The slope 55 of the latch 50 ensures smooth movement of the latch 50 to the locking position from the releasing position.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A detachable top tube apparatus including:
two tubes each including a rectangular end formed with two planar faces and a circular end telescopically connected to the circular end of the other tube;
two hooks each including a portion inserted in a related one of the tubes;
two latches each pivotally connected to a related one of the tubes between a releasing position to allow a portion of a bicycle to be hooked by and unhooked from the related hook and a locking position to retain the portion of the bicycle hooked by the related hook, wherein each of the latches includes two wings in tight contact with the planar faces of the rectangular end of the respective one of the tubes to render the connection of the latch to the tube firm, wherein one of the wings of each of the latches includes an aperture defined therein;
two spring-biased detents each connected to the rectangular end of a respective one of the tubes, wherein each of the spring-biased detents stays in the aperture of the respective wing without extending beyond the respective wing when the respective spring-biased detent is in the locking position; and
an elastic rope for interconnecting the tubes.

2. The detachable top tube apparatus according to claim 1, wherein the elastic element is an elastic rope.

3. The detachable top tube apparatus according to claim 1, wherein one of the wings includes a slope for sliding on the spring-biased detent to push the spring-biased detent into the tube from the aperture of the wing during the pivoting of the latch into the locking position from the releasing position.

4. The detachable top tube apparatus according to claim 3, wherein the slope is at an increasing distance from the other wing toward edges of the wings.
